(19) United States
(12) Patent Application Publication
(10) Pub. No.: US 2015/0238992 A1
(43) Pub. Date: Aug. 27, 2015

(54) DOLLY

(71) Applicants: Ryan Moran, Delaware, OH (US); Michael Sakich, Powell, OH (US); Charles White, Plain City, OH (US)

(72) Inventors: Ryan Moran, Delaware, OH (US); Michael Sakich, Powell, OH (US); Charles White, Plain City, OH (US)

(73) Assignee: HONDA MOTOR CO., LTD., Tokyo (JP)

(21) Appl. No.: 14/187,664

(22) Filed: Feb. 24, 2014

(51) Int. Cl. B05B 15/12

(52) U.S. Cl. CPC B05B 15/1292

(57) ABSTRACT

An apparatus includes a dolly configured to carry a paint body through a curing oven. The dolly is made of a material that has a higher specific heat capacity than that of carbon steel, has a lower mass than known standard dollies, is insulated, or combinations thereof such that the overall energy required to heat and cool the dolly is reduced relative to known standard dollies.

### BACKGROUND

The technology described herein relates to a dolly for use in a paint facility, such as in a paint shop in the automotive industry. Paint dollies are used to carry paint bodies (such as vehicle or automobile bodies) through the paint shop and through paint curing ovens. A standard painting process often requires a total of six different curing ovens or more. These prior art dollies are also typically made of carbon steel. Carbon steel is a low specific heat capacity material, meaning that it has high thermal conductivity that permits it to heat up and gather a significant amount of heat during the painting and curing process. As the dolly travels through the oven, it absorbs heat, which requires that more natural gas be used in the curing process in order to maintain the desired oven temperature. After removal of the paint body and dolly from the curing oven, the building air conditioning has to cool the dolly back down to ambient temperature. This also requires that a significant amount of energy be utilized to cool the dolly along with the paint body.

### SUMMARY

According to one aspect, an apparatus includes a dolly configured to carry a paint body through a curing oven. The dolly is made of a material that has a higher specific heat capacity than that of carbon steel, has a lower mass than known standard dollies, is insulated, or combinations thereof such that the overall energy required to heat and cool the dolly is reduced relative to known standard dollies.

According to another aspect, a dolly for use in a painting and curing process includes an apparatus configured to carry a paint body through a painting process and curing oven. The dolly also includes thermal shielding insulation associated with the apparatus to deter heat from the oven from reaching the apparatus.

According to another aspect, a method for saving energy during a paint curing activity is provided. The method includes providing a dolly configured to carry a paint body through a curing oven. The dolly is made of a material that has a higher specific heat capacity than 0.12 BTU/lb. ° F., a lower thermal conductivity due to a reduced weight relative to a known standard dolly, includes an insulation that is associated with the dolly to deter heat from reaching the dolly, or a combination thereof.

### BRIEF DESCRIPTION OF THE DRAWINGS

FIG. 1 is a schematic view of an example dolly in use in a paint shop;

FIG. 2 is a schematic view of a another example dolly; and

FIG. 3 is a schematic view of an example curing process for a paint body in a paint shop.

### DETAILED DESCRIPTION

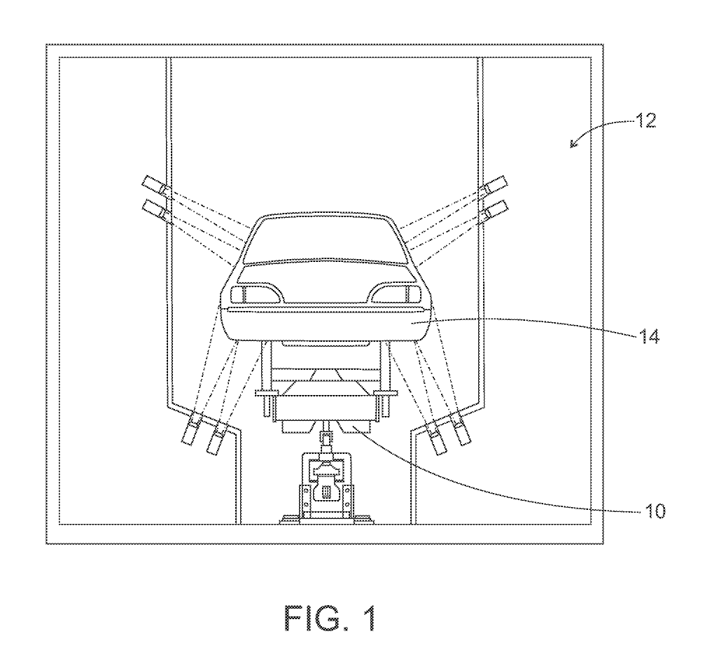

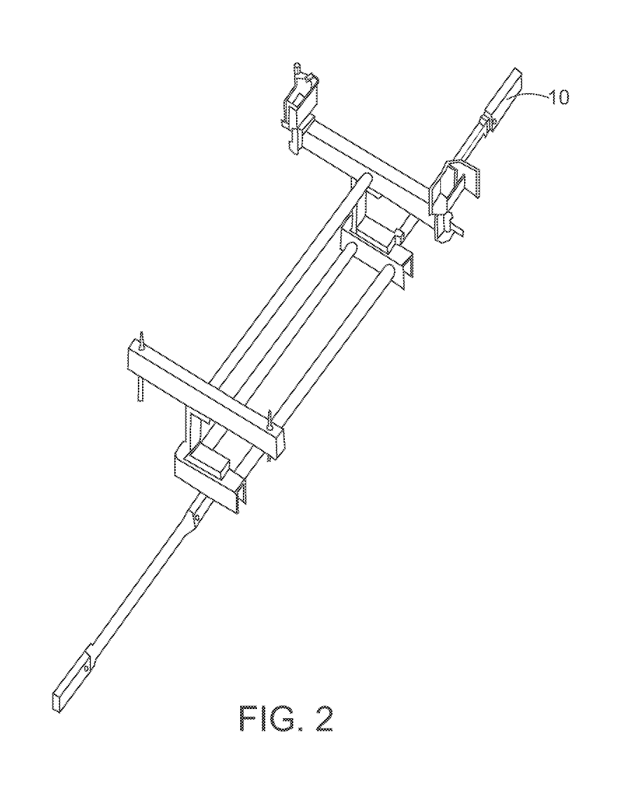

Referring now to the drawings, wherein the showings are for purposes of illustrating one or more exemplary embodiments and not for purposes of limiting same, FIGS. 1-3 illustrate an example dolly 10 that is utilized in a paint station 12 of a paint shop for carrying a paint body or part 14. For example, the dolly 10 may be used in the automotive field in order to permit the painting of vehicle body 14. The paint body 14 travels through a curing oven or stations 16 in order to properly cure the paint body 14. The dollies 10 are of a size that permits the easy transport of the automobile body 14 through the painting and curing stations 12, 16 within the paint shop. The dolly 10 may take any known shape for transporting the paint body 14 along an assembly line. Several example dollies are depicted in FIGS. 1 and 2.

An example dolly 10 is shown and described herein that, in a first embodiment, is made of a material that has a higher specific heat capacity than is known for prior art dollies, which are made of carbon steel. If a dolly is made of a material that has a higher specific heat capacity, it means that it can withstand high temperatures without gathering as much heat as dollies made of lower specific heat capacity materials that are of the same weight. Thus, the dolly 10 has a lower thermal conductivity in order to avoid gathering and storing excessive heat.

Heat capacity, or thermal capacity, is the measurable physical quantity that specifies the amount of heat energy required to change the temperature of an object or body by a given amount. Specific heat capacity is the heat capacity per unit mass of a material. An object's heat capacity is defined as the ratio of the amount of heat energy transferred to an object and the resulting increase in temperature of the object. Heat capacity is an extensive property of matter, meaning it is proportional to the size of the system. A sample containing twice the amount of substance as another sample requires the transfer of twice the amount of heat to achieve the same change in temperature. It is often more convenient to express heat capacity as an intrinsic characteristic of a substance, which is accomplished by expressing the property in relation to a unit of mass, which is referred to as the “specific” heat capacity.

There are a number of different ways that the heat capacity of an object can be varied. In one example, the dolly 10 may be made of a material that has a higher specific heat capacity than prior art dollies that are made of carbon steel, such that the temperature of the material of the dolly 10 does not readily increase as much as carbon steel with the application of heat. For example, the dolly 10 may be molded of materials, such as glass-filled polymers, polycarbonate, resin, carbon fiber, fiberglass, or other metals, such as aluminum, or a combination thereof

In another example, the weight of the dolly 10 may be decreased relative to prior art dollies such that the overall heat capacity of the dolly is reduced due to its smaller size. In this example, the specific heat capacity of the material may be the same or similar to that of carbon steel, but the amount of material at issue will be less. Thus, while the material may heat up as much as the prior art dolly, because there is less material, it heats and cools with the application of less heat application and less air conditioning, respectively. Thus, in this example, the overall heat capacity of the dolly 10 may be lower than that of the prior art dolly, even if the specific heat capacity of the material used for the dolly is the same or similar to that used in prior art dollies. Typically prior art dollies are manufactured with durability in mind. As such, little concern is given to optimizing their size and/or shape in order to minimize the amount of heat they could gather or store. The example dolly 10 takes into consideration the overall weight such that the overall heat capacity is actually lowered relative to prior art dollies. This feature may be used separately or in combination with other examples described herein in order to provide an improved dolly for use in a paint shop. The example dolly 10 is capable of performing all the functions of prior art dollies that are used in paint shops for moving paint bodies 14, such as vehicle bodies, but requires much less energy to cure and cool the paint bodies 14 because of the changed configuration of the dolly 10.

In another example, the dolly 10 is insulated so that it cannot easily absorb or store heat. For example the dolly 10 may be coated with an insulating material so that heat is not readily transferred to the dolly. Insulation may be applied in any known manner, such as by wrapping or adhering an insulating material to the dolly. The insulation may be formed in a layer that is positioned around an outer surface of the dolly. The insulation may be applied with connectors. The insulation may be flexible and is durable enough to withstand forces typically associated with use in an automotive environment. The insulation may be a fiberglass tube, board, blanket, or sheet. The insulation may be a rock wool tube, board, blanket or sheet. The insulation may be an elastomeric tube, board, blanket, or sheet. The insulation may be a spray coated foam, a fiberglass wrap, molded or thrown over the top of the dolly. The insulation may be a ceramic, such as a mud-style coating. In the event that steel is used as a reinforcement or otherwise, only the steel could be isolated from the heat, if desired, so that the steel does not easily absorb heat. Any known insulating material may be used, including materials that are painted or blown on, or the like.

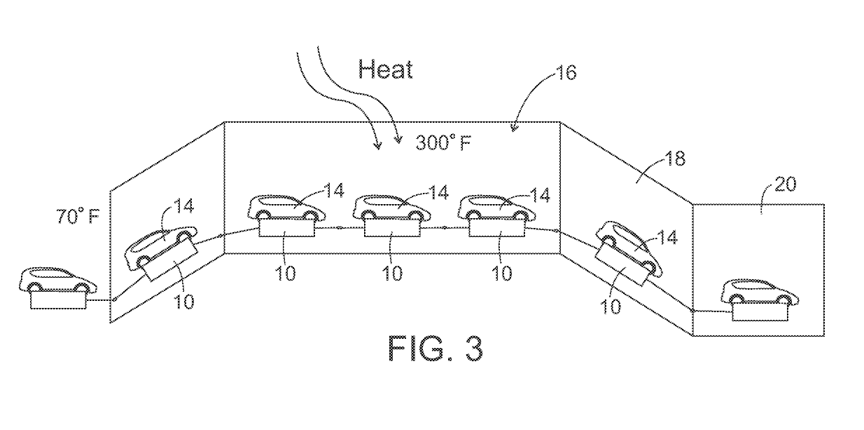

Referring to FIG. 3, in a typical automotive paint shop, vehicle bodies 14 are set on dollies 10 that hook to a chain and are pulled through the paint station 12 and the curing ovens 16. The dollies 10 and vehicle bodies 14 start at a temperature of around 70° F. In a typical paint shop, the dollies 10 travel through six (6) or more curing ovens 16. The curing oven 16 is used to cure the paint and raises the temperature of both the vehicle body 14 and the dolly 10 to around 300° F. The vehicle body 14 (and dolly 10) is partially cooled in a cooling tunnel 18. Then the car 14 and dolly 10 are cooled back down to 70° F. by the building's air conditioning 20. The extra cooling associated with cooling the dolly 10 back down to room temperature is undesirable. In addition, extra heating must be applied in the curing oven 16 to maintain a constant temperature because heat is absorbed by the dolly 10. When less energy is needed in order to cool and heat the dolly, energy costs may be reduced on the order of six times (due to the six different curing ovens), including lower air conditioning costs to cool the dolly 10 after curing and lower heating costs during the curing process.

Advantageously, steel may continue to be used in some cases as long as the overall weight is reduced or insulating materials are used. In this manner, the example dolly 10 is deterred from conducting heat, resulting in energy savings in connection with the curing and cooling operations. A typical or standard dolly weighs around 570 lbs. Carbon steel, which is presently used for prior art dollies, has a specific heat capacity of about 0.12 BTU/lb. ° F. Prior art dollies tend to be very heavy in weight. Specific heat is the heat required to raise the temperature of the unit mass of a given substance by one ° F. Lower specific heat capacity materials are undesirable in this context because they absorb heat more readily than higher specific heat capacity materials. Thus, total heat capacity for a typical dolly made of carbon steel and weighing 570 lbs. is 68.4 BTUs per ° F. Thus, it takes 68.4 BTUs to heat the typical/standard dolly by 1° F.

In a first example dolly 10, the weight of the dolly is reduced, even though carbon steel is still used. For example, if a revised dolly of carbon steel weighed 300 lbs. instead of 570 lbs., the total heat capacity would be 0.12 BTU/lb. ° F. multiplied by 300 lbs., or 36 BTU per ° F., as compared to 68 BTU per ° F. for the 570 lbs. dolly. Thus, when lower mass is used, the overall heat capacity needed to heat up the dolly is actually lower.

In a second example dolly 10, the configuration of the dolly is changed so that it more readily heats and cools. This also, in most cases, results in a lowering of the weight of the dolly. For example, different constructions for the dolly may be utilized without reducing the strength of the dolly, such as waffle construction, tubular construction, tubular construction filled with foam or resin, I-beam construction, or other know constructions. A dolly 10 could be made of a higher specific heat material, as discussed in greater detail below, but have reinforcements of steel either molded into the dolly or bolted onto the outside of the dolly. The steel can impart additional strength to a device that has a higher specific overall heat capacity. Other techniques also known by those of skill in the art can be used for reinforcing the dolly so that it can withstand the necessary forces, but have a lower overall weight and thus a lower overall heat capacity.

Another technique for reducing the amount of energy used to heat and cool a dolly is to make the dolly of materials that have lower thermal conductivity so that the material does not heat up as much when subjected to heat. For example, aluminum has a specific heat capacity of 0.22 Btu/lb. ° F. Total heat capacity for a standard dolly made of aluminum and weighing 570 lbs. would be 136.8 BTUs per ° F. Thus, aluminum has roughly half the overall heat capacity of carbon steel because it would require 136.8 BTU to raise the temperature of the material 1° F. versus it would only require 68.4 BTU per ° F. to raise the temperature of carbon steel 1° F.

Another possible material is polycarbonate, which has a specific heat capacity of 0.29 BTU/lb. ° F. to 0.31 BTU/lb. ° F. Total heat capacity for a 570 lb. dolly would be 165.3 BTUs per ° F. to 176.7 BTUs per ° F., which is significantly higher than the standard carbon steel dolly. Another possibility is carbon fiber, which has a specific heat capacity that varies widely with temperature, from about 0.17 BTU/lb. ° F. at room temperature to about 0.26 0.17 BTU/lb. ° F. at 300° F. At 300° F., which is the typical curing oven temperature, the total heat capacity for a standard sized dolly made with carbon fiber would be 148.2 BTUs per ° F., which is also significantly higher than the standard dolly made of carbon steel.

Yet another possibility is epoxy resin, which has a specific heat capacity of about 0.4 BTU/lb. ° F. A dolly weighing 570 lbs. that is made of epoxy resin would have a total heat capacity of 228 BTU per ° F. Thus, the higher the specific heat capacity, the lower the amount of heat that is gathered by a particular material during heating. Materials may be selected that have higher specific heat capacities than that of carbon steel, or that have overall lower thermal conductivity so that they don't gather heat as readily. Moreover, many of the materials described above have a much lower weight than that of carbon steel. As such, the overall weight of the dolly would likely be reduced significantly, resulting in a lower heat capacity than that of the same design made of carbon steel.

One example range of materials that may be utilized is materials having a specific heat capacity that is greater than about 0.13 BTU/lb. ° F. Another example range of materials that may be utilized are materials having a specific heat capacity that is greater than about 0.2 BTU/lb. ° F.

Another example design has an overall heat capacity that is less than that of carbon steel per unit mass.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. An apparatus comprising:
a dolly configured to carry a paint body through a curing oven, wherein the dolly is made of a material that has a higher specific heat capacity than that of carbon steel, has a lower mass than known standard dollies, is insulated, or combinations thereof such that the overall energy required to heat and cool the dolly is reduced relative to known standard dollies.

2. The apparatus of claim 1, wherein the dolly material has a higher specific heat capacity than that of carbon steel at about 300° F.

3. The apparatus of claim 1, wherein the dolly material is a glass-filled polymer, a polycarbonate, a resin, a carbon fiber, a fiberglass, aluminum, or combinations thereof.

4. The apparatus of claim 1, further comprising:
an insulation material associated with the dolly for shielding the material of the dolly from collecting heat in an oven.

5. The apparatus of claim 4, wherein the insulation material is formed in a layer that is positioned around an outer surface of the dolly.

6. The apparatus of claim 4, wherein the insulation material is fiberglass.

7. The apparatus of claim 4, wherein the insulation has a low thermal conductivity such that the dolly is deterred from heating up during an oven curing process.

8. The apparatus of claim 4, wherein the insulation is flexible.

9. The apparatus of claim 4, wherein the insulation material is a layer that is applied with an adhesive or with connectors.

10. The apparatus of claim 1, wherein the dolly material has a specific heat capacity that is equal to or greater than 0.2 BTU/lb. ° F.

11. The apparatus of claim 1, wherein the dolly is formed by molding.

12. A dolly for use in a painting and curing process comprising:
an apparatus configured to carry a paint body through a painting process and curing oven; and
thermal shielding insulation associated with the apparatus to deter heat from the oven from reaching the apparatus.

13. The dolly of claim 12, wherein the thermal shielding is an insulating layer wrapped around or applied to at least part of the apparatus.

14. The dolly of claim 13, wherein the insulation layer is a fiberglass tube, board, blanket, or sheet, or a rock wool tube, board, blanket, or sheet, or an elastomeric tube, board, blanket, or sheet.

15. The dolly of claim 12, wherein the dolly material has a lower thermal conductivity or a lower overall heat capacity than a known standard dolly.

16. A method for saving energy during a paint curing activity comprising:
providing a dolly configured to carry a paint body through a curing oven, wherein the dolly is made of a material that has a higher specific heat capacity than 0.12 BTU/lb. ° F., a lower thermal conductivity due to a reduced weight relative to a known standard dolly, includes an insulation that is associated with the dolly to deter heat from reaching the dolly, or a combination thereof.

17. The method of claim 16, wherein the dolly is an automobile dolly utilized in the painting process of an automobile.

18. The method of claim 16, further comprising:
applying an insulating material to an exterior surface of the dolly, an interior surface of the dolly, or combinations thereof.
